(19) United States
(12) Patent Application Publication
(10) Pub. No.: US 2025/0006992 A1
(43) Pub. Date: Jan. 2, 2025

(54) LOW-CONCENTRATION ELECTROLYTE FOR SUPPRESSING DENDRITE GROWTH IN LITHIUM METAL

(71) Applicants: Quinn Qiao, Jamesville, NY (US); Abiral Baniya, Syracuse, NY (US)

(72) Inventors: Quinn Qiao, Jamesville, NY (US); Abiral Baniya, Syracuse, NY (US)

(73) Assignee: Syracuse University, Syracuse, NY (US)

(21) Appl. No.: 18/577,840

(22) PCT Filed: Jul. 8, 2022
(86) PCT No.: PCT/US22/36461

§ 371 Date: Jan. 9, 2024

Related U.S. Application Data
(60) Provisional application No. 63/220,299, filed on Jul. 9, 2021.

(51) Int. Cl. H01M 10/0567; H01M 4/02; H01M 4/38; H01M 10/0525; H01M 10/0562; H01M 10/0569

(52) U.S. Cl. CPC H01M 10/0567; H01M 4/382; H01M 10/0525; H01M 10/0562; H01M 10/0569; H01M 2004/027; H01M 2300/0028; H01M 2300/0068

(57) ABSTRACT

An electrolyte for a lithium battery containing a low concentration of gadolinium nitrate (Gd(NO₃)₃). In an electrolyte of 1 M lithium bis(trifluoromethanesulfonyl)imide (LiTFSI), DME:DOL (1:1), and 1% LiNO₃, 1 mg/ml of Gd(NO₃)₃ as additive will promote the plating/stripping of lithium metal with nodular morphology and support dendrite suppression so that less dead lithium is formed on Li anode surface.

### BACKGROUND OF THE INVENTION

### 1. Field of the Invention

The present invention relates to lithium metal batteries and, more particularly, to an electrolyte that can suppress the growth of dendrites in the solid electrolyte interphase (SEI) layer.

### 2. Description of the Related Art

Lithium (Li) metal as anode has been considered as the “holy grail” for lithium metal batteries application due to its high theoretical specific capacity (3840 mAhg⁻¹) and low reduction potential (−3.04V versus standard hydrogen electrode). However, the formation of an unstable solid electrolyte interphase (SEI) layer and uncontrolled lithium (Li) dendrite growth are two major obstacles that hinder the use of Li metal as Li batteries anode. Strategies such as the use of electrolyte additives (usually <5-10 wt %) in either ether or carbonate based liquid electrolytes and protective coating against reduction of Li metal that are thermodynamically stable or that form stable passivation (artificial SEI) layers against lithium metal are mainly employed to overcome these obstacles.

The correlation between the additive chemistries and electrochemical performances when the electrolyte additives are used in Li-ion batteries has been elucidated. The analysis of the use of additives on bulk electrolyte and surfaces of electrodes shed the light on complicated reactions that cascades among these additives with electrolyte and electrode components. It was found that the effectiveness of these additives lies not only in how they participate the interphasial chemistries, but also in how they suppress the major side reactions between the bulk electrolyte solvents, the trans-esterification.

Some have proposed that an optimal amount (2 wt %) of lithium iodide (LiI) as a functional additive in ether-based electrolyte can promote dendrite-free Li deposition. In addition, others have showed the long-term stability of Li—S batteries using high concentration of lithium nitrate (LiNO₃) in electrolytes. A new electrolyte system based on high concentration of LiNO₃ in diglyme (G2) solvent was developed that enabled very high coulombic efficiency (CE) for Li metal plating/stripping. Similarly, some have used Zirconium oxynitrate (ZrO(NO₃)₂) as a functional additive to suppress the diffusion of polysulfide shuttles in lithium-sulfur batteries. The NO₃ anions get reduced by Li to form a stable passivation layer on Li-metal anode, which is beneficial to decrease the Li side-reactions and stabilizing the surface topography of Li-metal anode. Furthermore, others have introduced LiNO₃ regulated sulfone electrolytes for Lithium metal batteries. For stability enhancement of electrolytes, LiNO₃ and 1,1,2,2-tetrafluoroethyl-2′,2′,2′-trifluoroethyl (HFE), were introduced to the high-concentration sulfolane electrolyte. This resulted in suppression Li dendrite growth and enabled achieving of high Coulombic efficient >99% for both Li anode and NMC cathodes. Nevertheless, there remains a need for a lithium metal electrolyte that avoids dendrite formation.

### BRIEF SUMMARY OF THE INVENTION

The present invention comprises the use of superior nitrate anion chemistry against Li metal by introducing gadolinium nitrate (Gd(NO₃)₃) as an electrolyte additive in ether based liquid electrolytes. Gadolinium is used to form a superior solid electrolyte interphase (SEI) layer with low resistance, high Young's modulus, and ionic conduction. The SEI layer usually forms during the first cycling of battery, and it functions as a protective layer, preventing electrolyte/electrode depletion. It also helps suppress of lithium dendrite growth by passivating the Li metal anode surface.

In one embodiment, the present invention is electrolyte for a lithium metal battery comprising an amount of gadolinium nitrate. The amount of gadolinium nitrate comprises one milligram per milliliter of electrolyte. The electrolyte may include an amount of lithium bis(trifluoromethanesulfonyl)imide. The electrolyte may include an amount of 1,3-dioxolane. The electrolyte may include an amount of 1,2-dimethoxyethane. The electrolyte may include an amount of lithium nitrate. The electrolyte may be characterized by a wettability contact angle of 13.50 degrees. The electrolyte is in contact with and forms a solid electrolyte interphase with a lithium metal anode. A portion of the gadolinium nitrate is present in the solid electrolyte interphase.

The present invention further comprises a method of protecting a lithium metal anode against dendrite growth. The method includes the step of providing an amount of gadolinium nitrate in an electrolyte that is in contact with and forms a solid electrolyte interphase with the lithium metal anode. The amount of gadolinium nitrate may comprise one milligram per milliliter of electrolyte. A portion of the gadolinium nitrate is present in the solid electrolyte interphase.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of an electrolyte according to the present invention in a lithium metal matter and depictions of a lithium anode in combination with an electrolyte according to the present invention as compared to a conventional electrolyte;

FIG. 2 is a series of SEM images comparing the nodular morphology of lithium plating/stripping when Gd(NO₃)₃ is used as an additive in an ether based liquid electrolyte with an electrolyte that lacks the Gd(NO₃)₃;

FIG. 3 is a pair of images showing the contact angle measurement of electrolytes on Li metal (a) with Gd(NO₃)₃ additive (b) without Gd(NO₃)₃ additive:

FIG. 4A is a graph of the electrochemical stability of additive engineered Li/Li cells showing Nyquist plots of Li-symmetrical cells with and without Gd(NO₃)₃ additive; and

FIG. 4B is a graph of the electrochemical stability of additive engineered Li/Li cells showing galvanostatic cycling performance at constant current densities of 0.5 and 2 mA cm⁻².

FIG. 4C is a graph of the electrochemical stability of additive engineered Li/Li cells showing galvanostatic cycling performance at constant current densities of 2 and 1 mA cm⁻².

FIG. 5A is a graph of Gd 4d XPS spectra of cycled Li metal anode without Gd(NO₃)₃ additive in the electrolyte.

FIG. 5B is a graph of Gd 4d XPS spectra of cycled Li metal anode with Gd(NO₃)₃ additive in the electrolyte.

FIG. 6A is a graph of the charge/discharge voltage profile of LFP/Li full cell at C-rate of 1C.

FIG. 6B is a graph of the rate capability and retention comparison of LFP coupled with and without electrolyte additive.

FIG. 6C is a graph of the long-term cycling performance of LFP/Li full cells at C-rate of 1C.

### DETAILED DESCRIPTION OF THE INVENTION

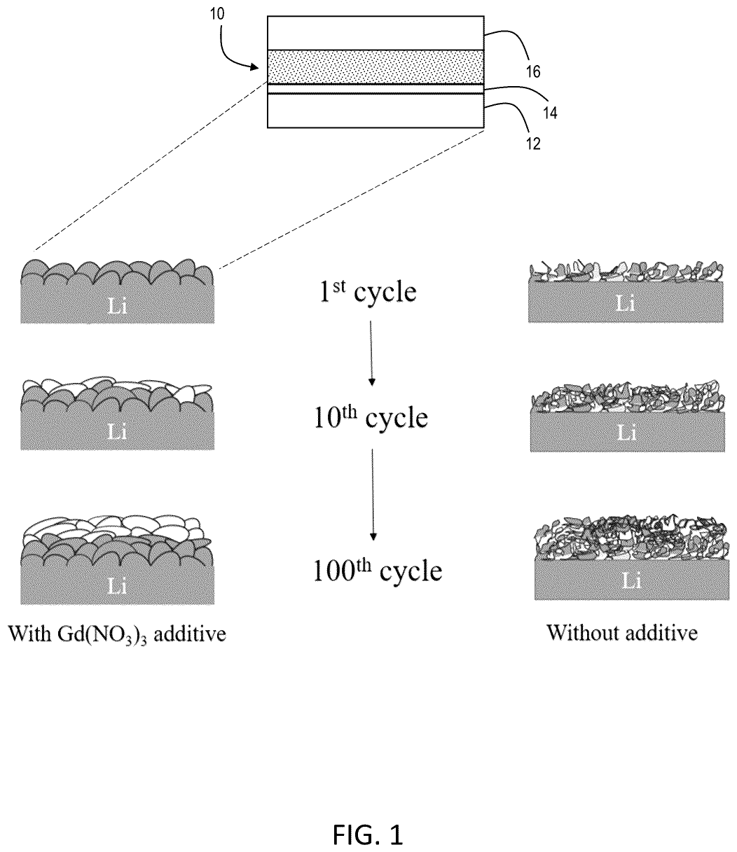

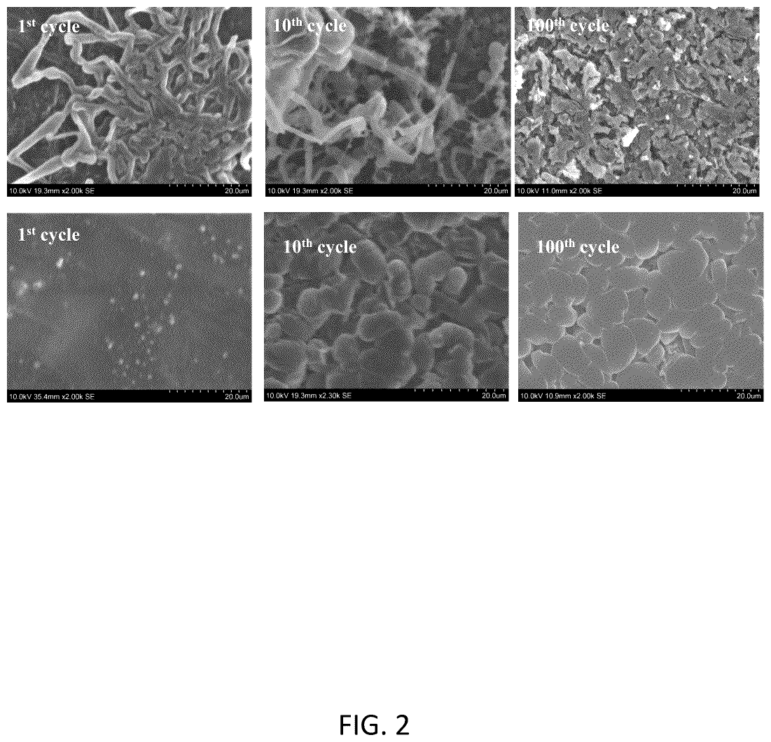

Referring to the figures, wherein like numerals refer to like parts throughout, there is seen in FIG. 1 an approach according to the present invention for suppressing lithium dendrite growth in a lithium metal battery using gadolinium nitrate (Gd(NO₃)₃) in the electrolyte 10 positioned between the lithium metal anode 12 and the cathode 16. Electrolyte 10 is in contact with the lithium metal anode 12 and is incorporated into the solid electrolyte interphase 14 that forms with lithium metal anode 12. Referring to SEM images of FIG. 2, the present invention provides for a nodular morphology of Lithium plating/stripping when Gd(NO₃)₃ is used as an additive in ether based liquid electrolyte.

Preliminary results show that only 1 mg/ml of Gd(NO₃)₃ as additive in 1 M lithium bis(trifluoromethanesulfonyl)imide (LiTFSI)+DME:DOL (1:1)+1% LiNO₃, promotes the plating/stripping of lithium metal with nodular morphology, which supports dendrite suppression as less dead lithium formation on Li anode surface. The nodular morphology of deposition is shown in FIG. 1 and FIG. 2 for 1^{st}, 10^{th} and 100^{th} cycle of Li plating/stripping, with and without Gd(NO₃)₃ additive. These micro-sized nodular Li structure with large particle size and small surface area decreases the side reactions between Li metal and electrolyte component enabling significantly improved coulombic efficiency (CE) and leading to enhanced cycling stability of Li metal batteries. Usually, nodular structures of Li are formed when Li deposits in highly concentrated electrolytes such as 4M lithium bis(fluorosulfonyl)imide (LiFSI)+DME, 7 M LiTFSI in DOL:DME, 4.5 M LiFSI in acetonitrile (AN), 4 M lithium nitrate (LiNO₃) in dimethylsulfoxide (DMSO), and 3M LiTFSI-DME. Although, according to solution theory, a higher fraction of free anions for solvation should result in stronger and faster solvency, the results here contradict this conventional wisdom demonstrating outstanding capabilities of dilute electrolytes enabled by use of additives. Batteries with diluted electrolytes are less expensive, lighter, have wide operating temperature and uses less viscous liquids compared to conventional 1M or high-M electrolytes. Further, the concentration of LiTFSI salt will be reduced to <0.1 M and the performance of battery as well as morphology of additive enabled lithium deposition will be observed. For example, some recent experiments showed the outstanding capability of a dilute (0.1 mol L⁻¹ of LiTFSI in DME/DOL with 1 wt % LiNO₃) electrolyte in lithium-sulfur batteries when the salt concentration was reduced to 0.1 M from 5 M and conventional 1 M electrolytes. However, their focus was to combat the polysulfide dissolution and cathode stability instead of Li dendrite suppression and nodular morphology of Li deposition.

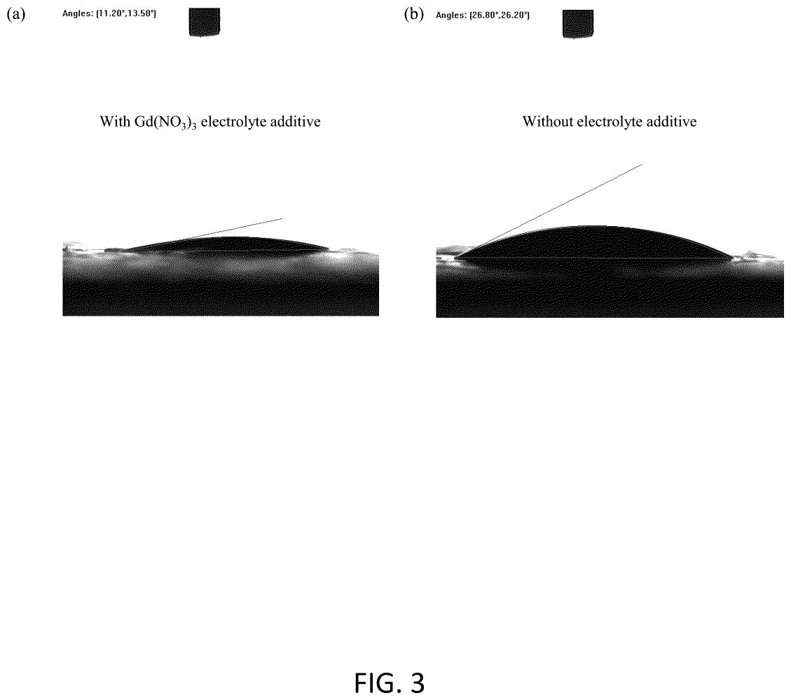

The wetting property of electrolytes of the present invention with Li metal was investigated using contact angle measurement on Li metal chip. The wetting of additive added electrolyte was better compared to conventional one as the contact angle decreased from 26.20° to 13.50°, as seen in FIG. 3. The increased wettability of electrolytes in Li metal will help in forming a stable SEI layer which further provides passivation from Li side reactions and dendrite formation.

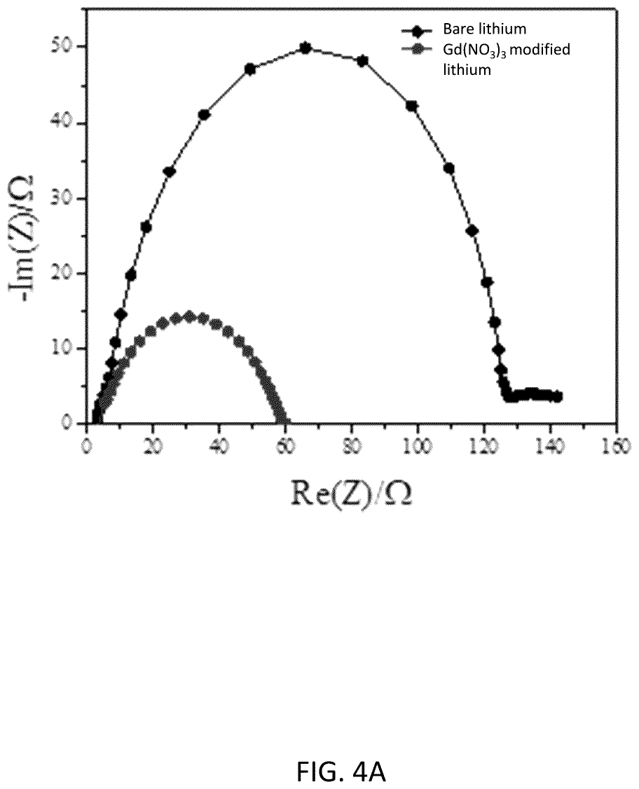

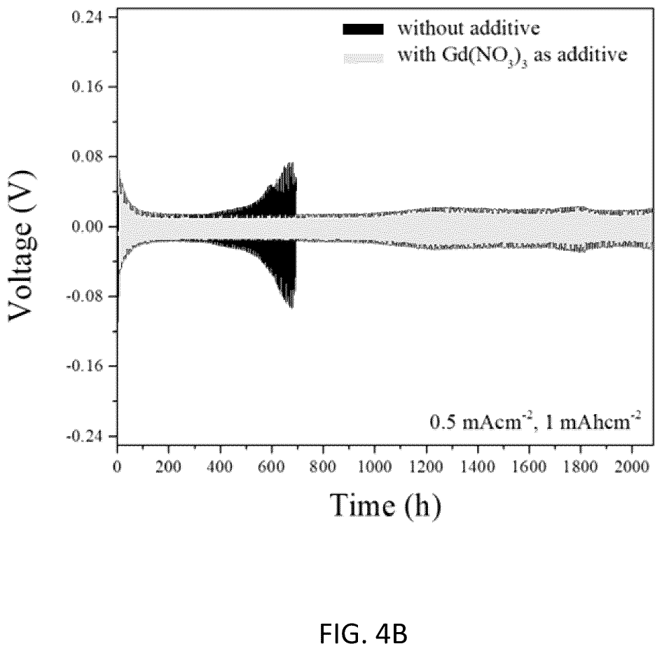

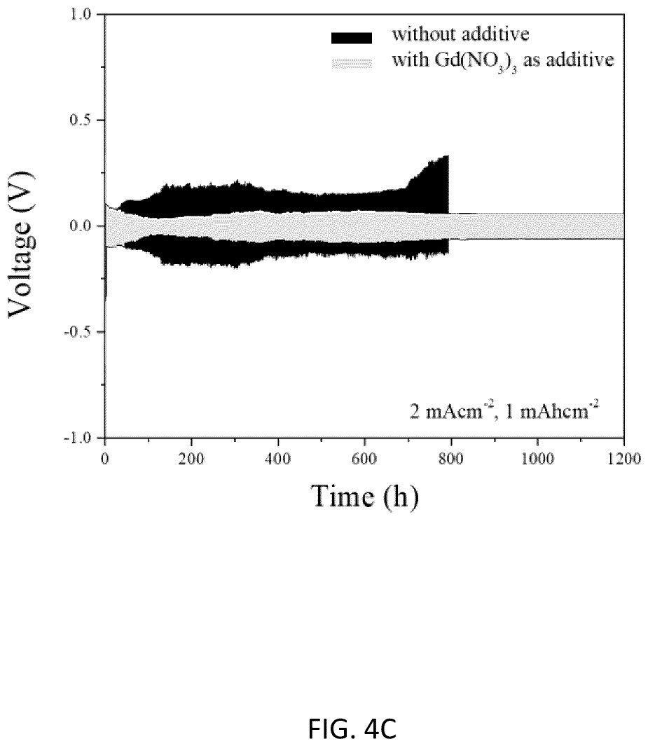

To observe Li plating/stripping stability, symmetric Li/Li coin-cells containing electrolytes with and without Gd(NO₃)₃ additives were assembled and tested in constant current densities of 0.5 mA cm⁻² (low) and 2 mA cm⁻² (high). The capacity for both high and low current density was set to 1 mAh cm⁻². The Nyquist plot (FIG. 4A) derived from electrochemical impedance spectroscopy (EIS) characterization shows that the introduction of Gd(NO₃)₃ additive reduces the total charge transfer impedance from 130 (2 to 60 (2. This significant reduction of charge transfer impedance can be attributed to Gd(NO₃)₃ additive promoting conformal formation of low resistance and ionically conductive SEI layer. Similarly, the galvanostatic Li plating/stripping cycling experiments (FIG. 4B) shows that the symmetric cell with no additive is plagued with unstable and high resistance SEI, as very large overpotential compared to additive engineering one is observed. Also, the cell with no additive becomes unstable only after 500 and 100 hours compared to 2200 and 1200 hours of stability shown by additive engineered cells at constant current density of 0.5 mA cm⁻² and 2 mA cm⁻², respectively.

Nitrate based additives are commonly used in lithium-sulfur batteries to effectively eradicate the polysulfide shuttle effect. However, it is also significant in suppressing lithium dendrite growth in lithium metal batteries. Additives during plating/stripping of ions have shown to aid in desolvation of Li⁺ ions providing efficient plating/stripping. In ether-based electrolytes, nitrate (e.g., LiNO₃ and NaNO₃) additives plays a critical role of interacting with Li⁺ solvation shells which changes the local environment of lithium-ions leading to variation in Li⁺ coordination number. This results in improved and efficient Li⁺ desolvation without lithium anode exfoliation. The improved Li⁺ desolvation promotes efficient Li⁺ plating/stripping at Li anode, improving the battery performance. Therefore, to analyze the desolvation chemistry of Li⁺ ions with and without additive there is a need to further characterize the composition of SEI film that is formed during first charge/discharge cycle. In depth X-ray photoelectron spectroscopy (XPS) of C 1s, F 1s and N1s spectra for cycled lithium anode in different electrolyte medium can reveal the products formed by the additive promoted reactions. These products are crucial in stable SEI layer formation. Therefore, XPS characterization was performed to examine the chemical and elemental states of SEI layer formed with and without Gd(NO₃)₃ additive.

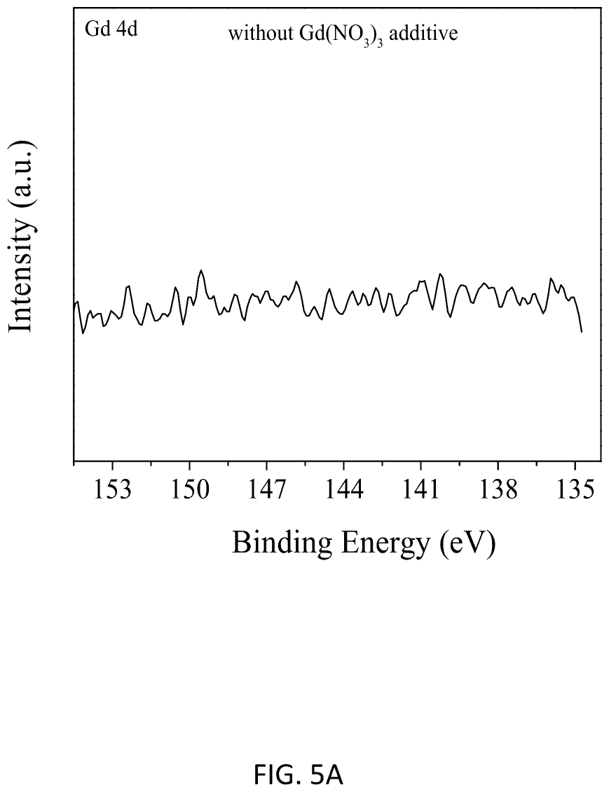

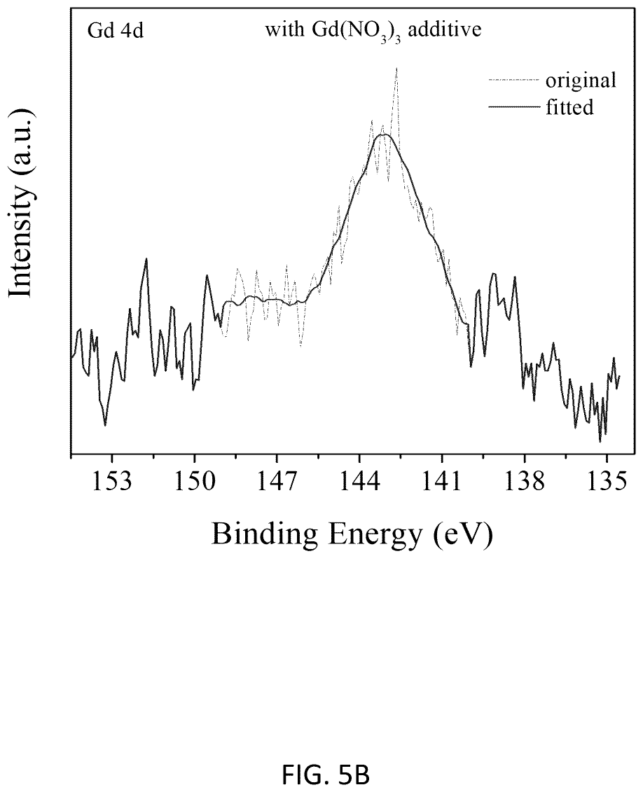

The XPS measurement of Li metal with electrolyte additive is seen in FIG. 5B. The main peak at 142.4 eV for Gd 4d is consistent with the formation of Gd₂O₃ in the SEI layer. However, this peak is missing in the electrolyte without additive (FIG. 5A). This shows the presence of gadolinium (Gd) in the SEI layer which improves the Li⁺ desolvation and are more stable in protecting Li metal against the electrolyte attack. Similarly, from XPS measurements of the C 1s, O 1s, F 1s, and Li 1s spectra were also performed and they showed that the SEI layers is composed of typical organic and inorganic compounds such as CH₂OCO₂Li, ROCO₂Li, and LiF. However, from the elemental composition table (see Table 1 below), it shows that the SEI layer in the Li metal anode formed from the electrolytes with nitrate additive consists of less oxygen, fluorine, and sulfur elements which are associated with LiTFSI lithium salt in the electrolyte. This indicates that the nitrate anions improves the stability of electrolytes against Li metal and prevents severe decomposition of lithium salt in electrolyte during battery operation.

TABLE 1
Elemental ratio (%) from various XPS analysis
with and without electrolyte additive

| XPS spectra | No additive | Gd(NO₃)₃ additive |
|---|---|---|
| C 1s | 27.6 | 30.1 |
| N 1s | 4.1 | 5.4 |
| O 1s | 23.3 | 20.8 |
| F 1s | 20.5 | 18.2 |
| S 2p | 7.4 | 6.8 |
| Li 1s | 17.1 | 18.5 |
| Gd 4d | 0.0 | 0.2 |

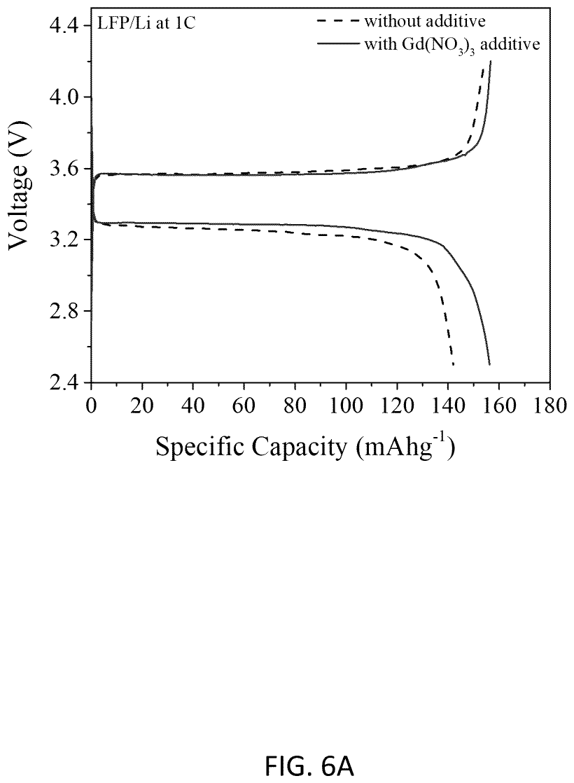

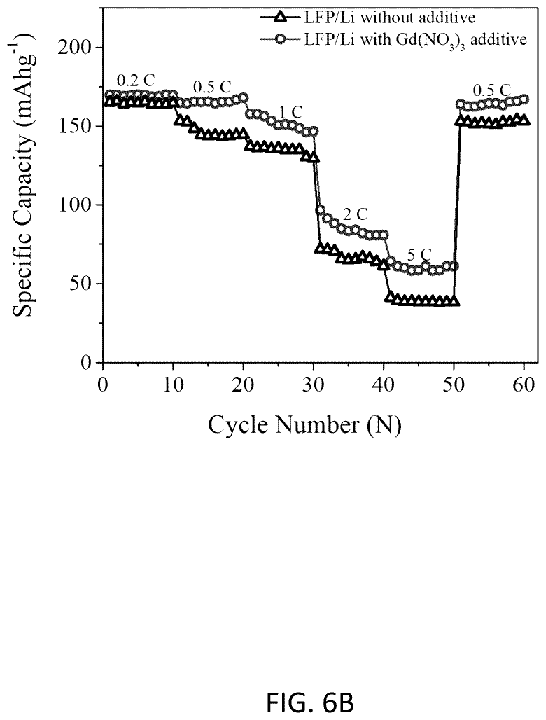

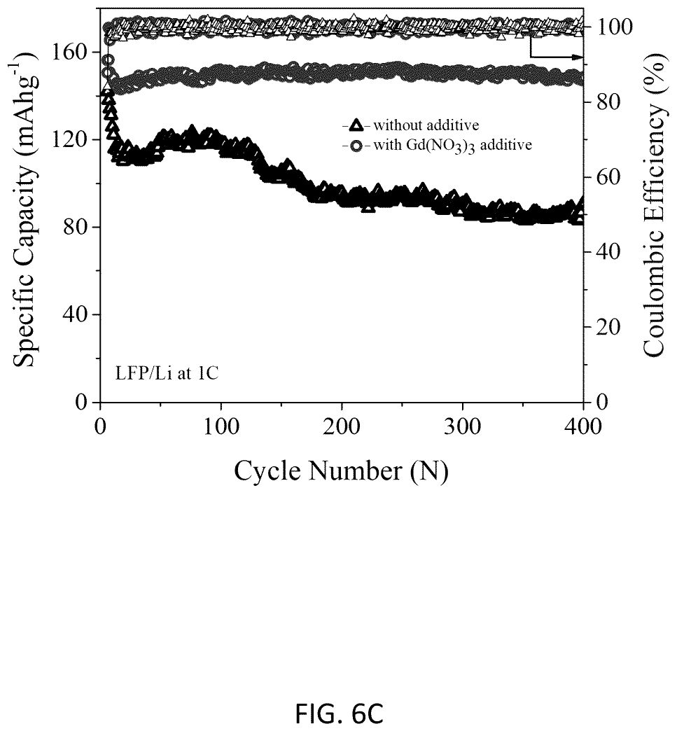

Further, to evaluate the potential application of present invention in practical batteries, lithium iron phosphate (LFP) cathode was assessed to assemble a full lithium metal battery (LMB). The cycling performance, discharging capacity and columbic efficiency (CE) were determined using these full cells for both with and without electrolyte additive. FIG. 6A shows the charge/discharge voltage profile of LFP/Li LMB at C-rate of 1C. The cell delivered first discharge capacities of 156.295 and 142.057 mAhg⁻¹ with CE of 87.819 and 84.112% for cells with and without Gd(NO₃)₃ additive respectively. The lower CE in cells without additive can be attributed to the side reactions and formation of unstable and fragile SEI, whereas the use of additive shows stabilized SEI and increase in CE. The LMB full cells were further cycled at various C-rates of 0.2, 0.5, 1, 2, and 5 C. As shown in FIG. 6B, the cell with/without electrolyte additive demonstrated discharge capacities of 169.83/165.075, 164.84/153.275, 157.69/137.05, 96.58/71.925, and 64.15/41.228 mAhg⁻¹ obtained at 0.2, 0.5, 1, 2, and 5 C, respectively. In addition, the cells with electrolyte additive displayed discharge capacity retention of 166.99 mAhg⁻¹ at 0.5 C which accounted for 98.33% of the initial capacity after ten cycles each of higher C-rates.

Similarly, the rate performance and capacity fade characteristics test were performed by cycling the LFP/Li cells at higher cycling number as shown in FIG. 6C, where the open circles and open triangles indicates the performance of cells with and without electrolyte additive respectively. FIG. 6C shows the much improved cycling performance of full cell using Gd(NO₃); additive added electrolyte, still maintaining the discharge capacity of 150.266 mAhg⁻¹ compared to 92.962 mAhg⁻¹ for cells without electrolyte additive at 400^{th} cycle. This improved cycling rate performance and reduced capacity fade further validate the efficacy of introducing Gd(NO₃)₃ as electrolyte additive and its contribution in forming a stable SEI layer, suppressing the Li dendrite growth and repressing the uncontrolled side reactions between electrolyte and Li metal anode.

Therefore, moving forward, it is useful to analyze the battery performance at ultra-low electrolyte concentration with additive and characterizing the effect of additives using techniques such as Raman, FTIR, NMR, etc. Additionally, full cell testing using high voltage cathode such as NMC 811 or highly stable cathode such as modified LFP may be performed on batteries with and without electrolyte additive. The rate capability and high temperature stability tests may also be performed.

What is claimed is:

1. An electrolyte for a lithium metal battery comprising an amount of gadolinium nitrate.

2. The electrolyte of claim 1, wherein the amount of gadolinium nitrate comprises one milligram per milliliter of electrolyte.

3. The electrolyte of claim 2, wherein the electrolyte further comprises an amount of lithium bis(trifluoromethanesulfonyl)imide.

4. The electrolyte of claim 3, wherein the electrolyte further comprises an amount of 1,3-dioxolane.

5. The electrolyte of claim 4, wherein the electrolyte further comprises an amount of 1,2-dimethoxyethane.

6. The electrolyte of claim 5, wherein the electrolyte further comprises an amount of lithium nitrate.

7. The electrolyte of claim 2, wherein the electrolyte is characterized by a wettability contact angle of 13.50 degrees.

8. The electrolyte of claim 1, wherein the electrolyte is in contact with and forms a solid electrolyte interphase with a lithium metal anode.

9. The electrolyte of claim 8, wherein a portion of the amount of gadolinium nitrate is present in the solid electrolyte interphase.

10. A method of protecting a lithium metal anode against dendrite growth, comprising the step of providing an amount of gadolinium nitrate in an electrolyte that is in contact with and forms a solid electrolyte interphase with the lithium metal anode.

11. The method of claim 10, wherein the amount of gadolinium nitrate comprises one milligram per milliliter of electrolyte.

12. The method of claim 11, wherein a portion of the amount of gadolinium nitrate is present in the solid electrolyte interphase

13. The method of claim 12, wherein the electrolyte further comprises an amount of lithium bis(trifluoromethanesulfonyl)imide.

14. The method of claim 13, wherein the electrolyte further comprises an amount of 1,3-dioxolane.

15. The method of claim 14, wherein the electrolyte further comprises an amount of 1,2-dimethoxyethane.

16. The method of claim 15, wherein the electrolyte further comprises an amount of lithium nitrate.

17. The method of claim 15, wherein the electrolyte is characterized by a wettability contact angle of 13.50 degrees.

18. The method of claim 10, wherein a discharge capacity of a battery containing the electrolyte and the lithium metal anode remains the same after 400 cycles.
